(19) United States
(12) Patent Application Publication
(10) Pub. No.: US 2007/0201841 A1
(43) Pub. Date: Aug. 30, 2007

(54) Liquid crystal television receiver

(75) Inventors: Jun Miura, Fukui (JP); Takashi Tokuda, Fukui (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/710,510

(22) Filed: Feb. 26, 2007

(30) Foreign Application Priority Data
Feb. 28, 2006 (JP) 2006-053247

(51) Int. Cl. H04N 5/00

(52) U.S. Cl. 386/125

(57) ABSTRACT

Depending on whether or not a disk device is mounted, a space produced in a liquid crystal television receiver is effectively used. Mounting holes for fixing a power substrate 12 to an LCD cover 8 are formed to the same size as mounting holes formed in an MPEG substrate 10 necessary for a disk device integrated type construction and fixed to mounting parts formed in the LCD cover 8. This makes it possible to remove the MPEG substrate 10 which is unnecessary in the case of a disk device non-integrated type construction, use the mounting parts formed in the LCD cover 8 for attaching the MPEG substrate 10 as mounting parts of the power substrate 12 as they are and eliminate the necessity for an outside power device such as an AC adapter.

The present application is based on and claims priority of Japanese patent application No. 2006-053247 filed on Feb. 28, 2006, the entire contents of which are hereby incorporated by reference.

### BACKGROUND OF THE INVENTION

1. Field of the Invention

The present invention relates to a liquid crystal television receiver provided with a substrate arrangement structure adaptable to both a disk device integrated type and a non-integrated type.

2. Description of the Related Art

In recent years, a liquid crystal television receiver is becoming increasingly slimmer and smaller and further space saving is being sought after by incorporating a disk device which allows video/audio data to be stored in a storage medium such as a DVD (Digital Versatile Disc) and HDD (Hard Disk Drive) In Japanese Patent Laid-Open Publication No. 2005-267773 (patent document 1), the present applicant discloses a method of reducing manufacturing cost of a small liquid crystal television receiver and a large-sized liquid crystal television receiver by achieving commonality of a disk device, disk device control substrate and main control substrate without the need for a dedicated substrate.

Furthermore, among liquid crystal television receivers of the same type, a liquid crystal television receiver in a construction not incorporating a disk device is also indispensable as an alternative for users in the aspects of cost and functions. However, according to the method disclosed in patent document 1, when a disk device non-integrated type construction is adopted, extra spaces are produced at positions where a disk device, disk device control substrate or the like are originally arranged.

Furthermore, when a liquid crystal panel is large, there is a wider space on the back surface of the liquid crystal panel making it possible to increase the area of mountable substrates, increase the number of substrates and provide a power substrate inside, whereas when the liquid crystal panel is small, for example, space on the back surface of a 14-inch liquid crystal panel is not wide enough to mount a power substrate, and therefore an outside power device such as an AC adapter is generally used.

### SUMMARY OF THE INVENTION

The present invention has been implemented in view of the above described problems and it is an object of the present invention to provide a liquid crystal television receiver capable of selecting a disk device integrated type construction or a non-integrated type construction, mounting a power substrate for a power supply on an extra space when the non-integrated type construction is adopted so as to effectively use the space.

The liquid crystal television receiver according to a first aspect of the present invention is a liquid crystal television receiver which can be configured as a disk device integrated type by comprising a liquid crystal panel which displays videos, a SCALER substrate which converts a video signal to a signal for displaying videos on the liquid crystal panel, a main substrate provided with a tuner which receives a broadcast radio wave and performs tuning or channel selection and a video/audio processing circuit and an outside input/output terminal or the like, power supply means for supplying power to the whole device through the main substrate, an LCD (Liquid Crystal Display) cover which is a cover for attaching the liquid crystal panel to protect the back of the liquid crystal panel and attaching various circuit substrates and the disk device or the like, a disk device capable of performing reproduction or recording and reproduction of a recording medium and a MPEG substrate which performs expansion and decoding of a video/audio signal obtained from the disk device, wherein the power supply means in the case of a disk device integrated type construction is used as an AC adapter connected from outside the device, the power supply means in the case of a disk device non-integrated type construction is used as a power substrate mounted inside the device, a plurality of mounting holes of the same size are formed for attaching the MPEG substrate and the power substrate to the LCD cover and mounting parts formed in the LCD cover for attaching the MPEG substrate and the power substrate are formed as common mounting parts to serve for both substrates, and the MPEG substrate is attached to the common mounting parts in the case of the disk device integrated type construction and the power substrate is attached to the common mounting parts in the case of the disk device non-integrated type construction.

According to the first aspect of the present invention, it is possible to mount the power substrate in the space produced when excluding the unnecessary MPEG substrate in the disk device non-integrated type construction by forming the mounting parts of the power substrate to the same size as the mounting parts of the MPEG substrate which is necessary for the disk device integrate type construction.

The liquid crystal television receiver according to a second aspect of the present invention is the liquid crystal television receiver according to the first aspect of the present invention, wherein mounting parts of the main substrate are arranged below the LCD cover, mounting parts of the disk device are arranged above mounting parts of the main substrate and at any one of left and right ends of the LCD cover, mounting parts for the SCALER substrate are arranged at an end opposite to the mounting parts of the disk device, and the common mounting parts are arranged above the mounting parts of the main substrate and at locations adjacent to the mounting parts of the disk device.

According to the second aspect of the present invention, the common mounting parts are arranged adjacent to the disk device. That is, it is possible to arrange the MPEG substrate attached to the common mounting parts adjacent to the disk device electrically connected thereto.

The liquid crystal television receiver according to a third aspect of the present invention is the liquid crystal television receiver according to the first or second aspect of the present invention, wherein the SCALER substrate and the power substrate are provided with mounting holes for mounting on the LCD cover formed at least in four corners of the substrates, the distance between the mounting holes is made to be equal for both substrates at least in a direction identical to a short side of the liquid crystal television receiver, the mounting parts for the SCALER substrate which are most distant from the disk device are positioned at a distance equal to the distance of the four mounting holes of the power substrate in a direction identical to a long side of the liquid crystal television receiver from the common mounting parts which are most distant from the disk device, and further mounting parts for replacement of substrates are positioned and formed at locations in a direction opposite to the disk device from the common mounting parts which are nearest from the disk device and at a distance equal to the distance of the mounting holes of the SCALER substrate in the same direction as that of the long side of the liquid crystal television receiver.

According to the third aspect of the present invention, the distance between the mounting holes formed in the SCALER substrate and the power substrate in a direction identical to the short side of the liquid crystal television receiver, that is, the distance in the vertical direction when the liquid crystal television receiver is installed is made equal for both substrates, further the mounting parts for the SCALER substrate are positioned at a distance equal to the distance between the mounting holes of the power substrate in a direction identical to the long side of the liquid crystal television receiver from the common mounting parts which are most distant from the disk device, that is in a direction identical to the horizontal direction when a liquid crystal television receiver is installed and further the mounting parts for replacement of substrates are formed at a distance equal to the distance between the mounting holes in the horizontal direction of the SCALER substrate from the common mounting parts which are nearest to the disk device when the liquid crystal television receiver is installed, and it is thereby possible to freely change the positional relation between the SCALER substrate and the power substrate.

The liquid crystal television receiver according to a fourth aspect of the present invention is the liquid crystal television receiver according to any one of the first to third aspects of the present invention, wherein the liquid crystal television receiver in the disk device integrated type construction arranges the MPEG substrate on the disk device in a multilayer form, and arranges the power substrate on the LCD cover instead of the MPEG substrate.

According to the fourth aspect of the present invention, it is possible to supply power through the power substrate without using any AC adapter in the liquid crystal television receiver having a disk device integrated type construction.

The liquid crystal television receiver according to a fifth aspect of the present invention is the liquid crystal television receiver according to any one of the first to fourth aspects of the present invention, wherein a diagonal length of a display section of the liquid crystal panel is 14 inches or 15 inches.

According to the fifth aspect of the present invention, it is possible to effectively use space without producing extra space inside the small liquid crystal television receiver having a diagonal length of the liquid crystal panel of 14 inches or 15 inches.

### BRIEF DESCRIPTION OF THE DRAWINGS

FIG. 1 is a front view showing a liquid crystal television receiver according to Embodiment 1 of the present invention;

FIG. 2 is a side view showing the liquid crystal television receiver according to Embodiment 1 of the present invention;

FIG. 3 is a plan view showing the liquid crystal television receiver according to Embodiment 1 of the present invention;

FIG. 4 is a rear view showing the liquid crystal television receiver according to Embodiment 1 of the present invention with a back cabinet removed;

FIG. 5 is a plan view showing various substrates attached to an LCD cover provided for the liquid crystal television receiver in a disk device integrated type construction according to Embodiment 1 of the present invention;

FIG. 6 is a plan view showing various substrates attached to the LCD cover provided for the liquid crystal television receiver in the disk device non-integrated type construction according to Embodiment 1 of the present invention;

FIG. 7 illustrates the positional relation between the power substrate and the SCALER substrate shown in FIG. 6 changed according to Embodiment 1 of the present invention; and

FIG. 8 is a plan view showing various substrates attached to an LCD cover according to Embodiment 2 of the present invention.

### DETAILED DESCRIPTION OF THE PREFERRED EMBODIMENTS

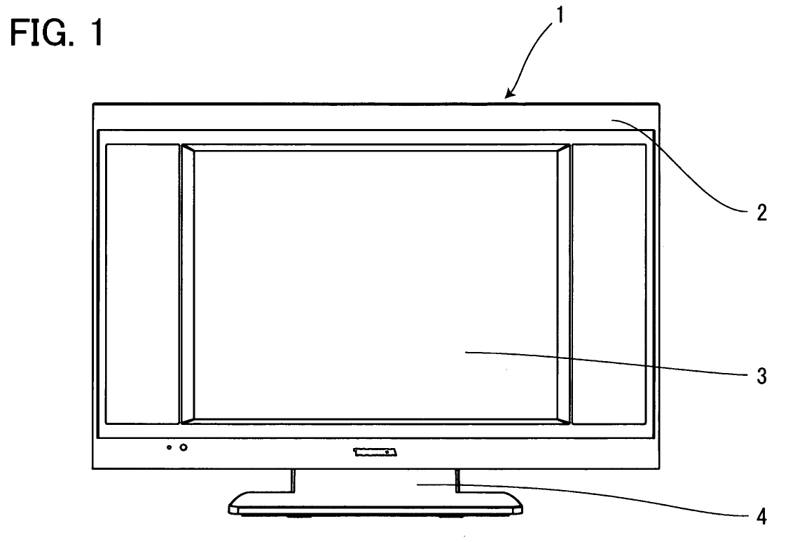

Hereinafter, embodiments as the best modes for implementing the present invention will be explained with reference to FIG. 1 to FIG. 8. It goes without saying that the present invention is also easily applicable to modes other than those explained in the embodiments within a range not departing from the essence of the present invention.

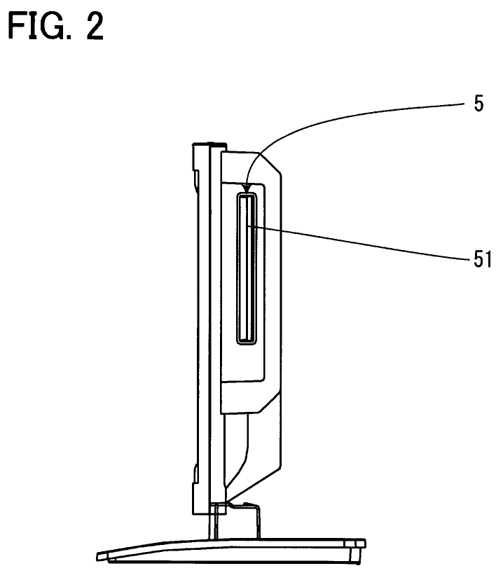

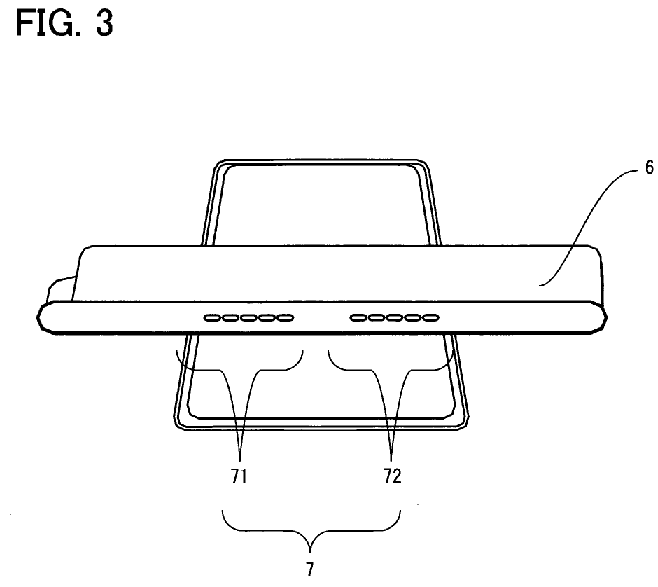

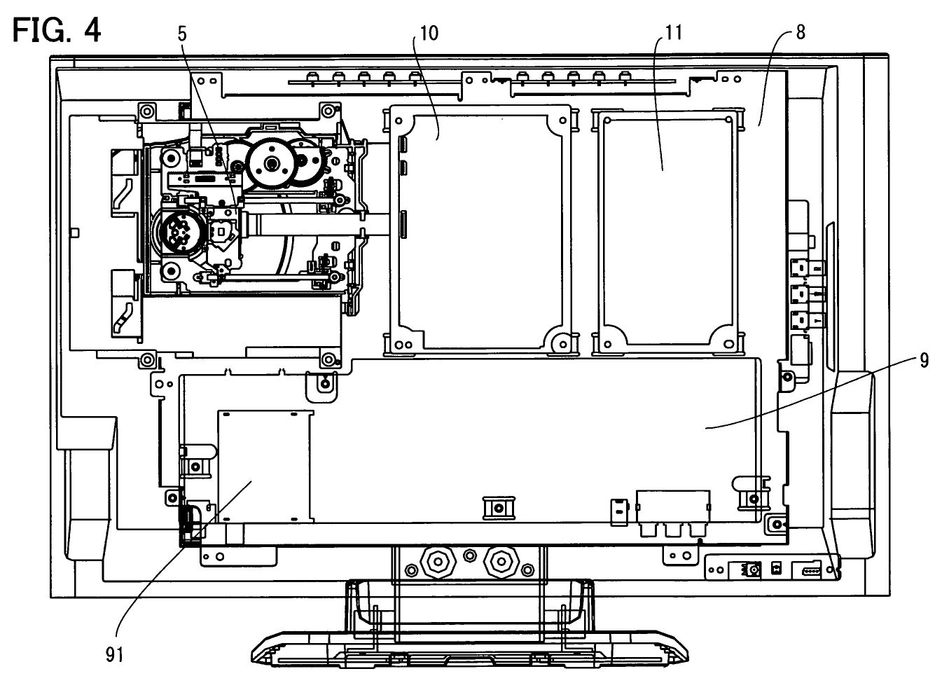

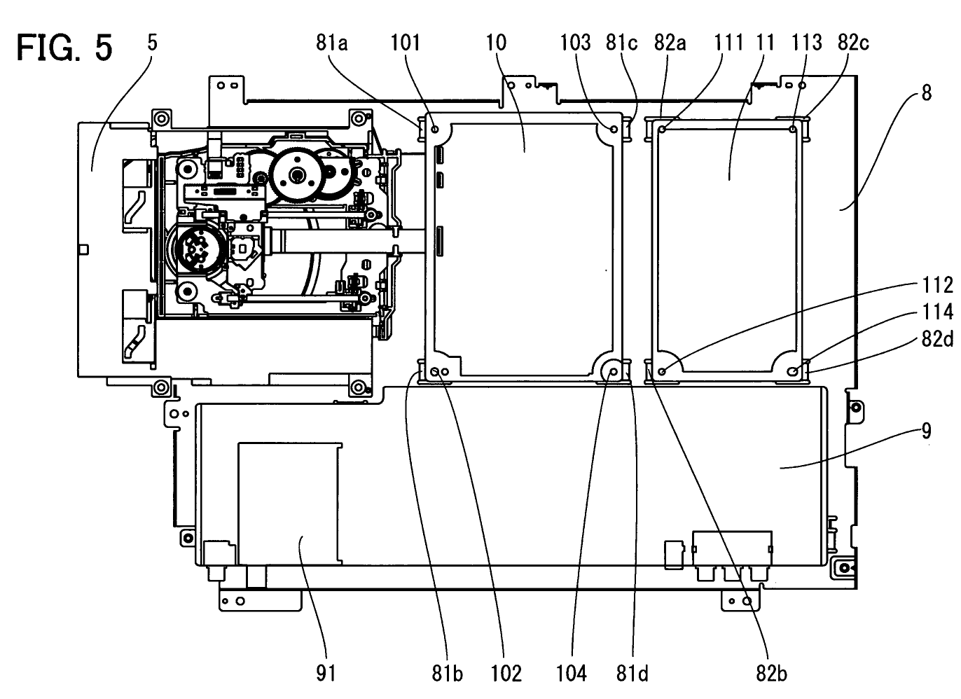

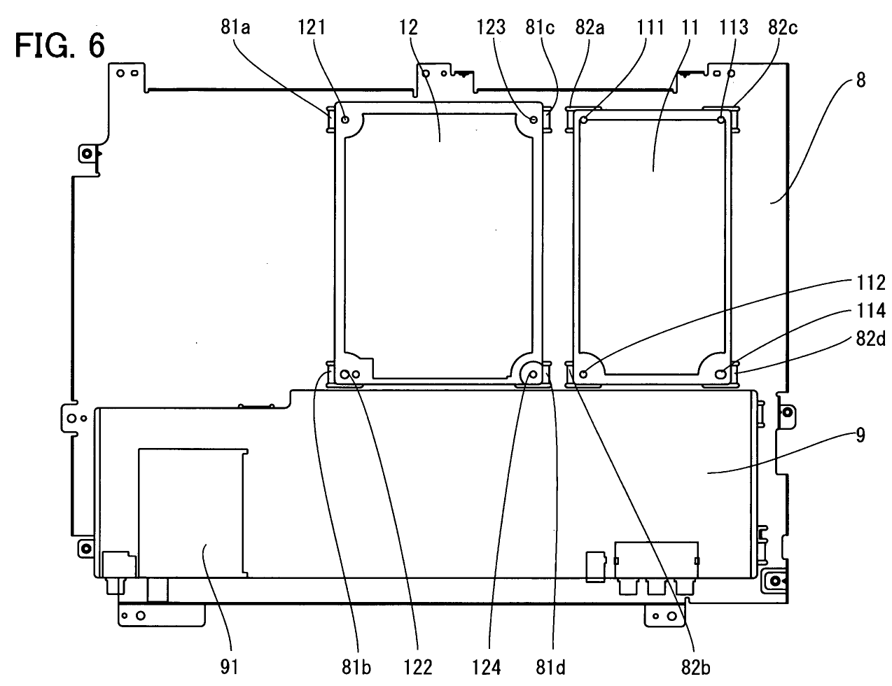

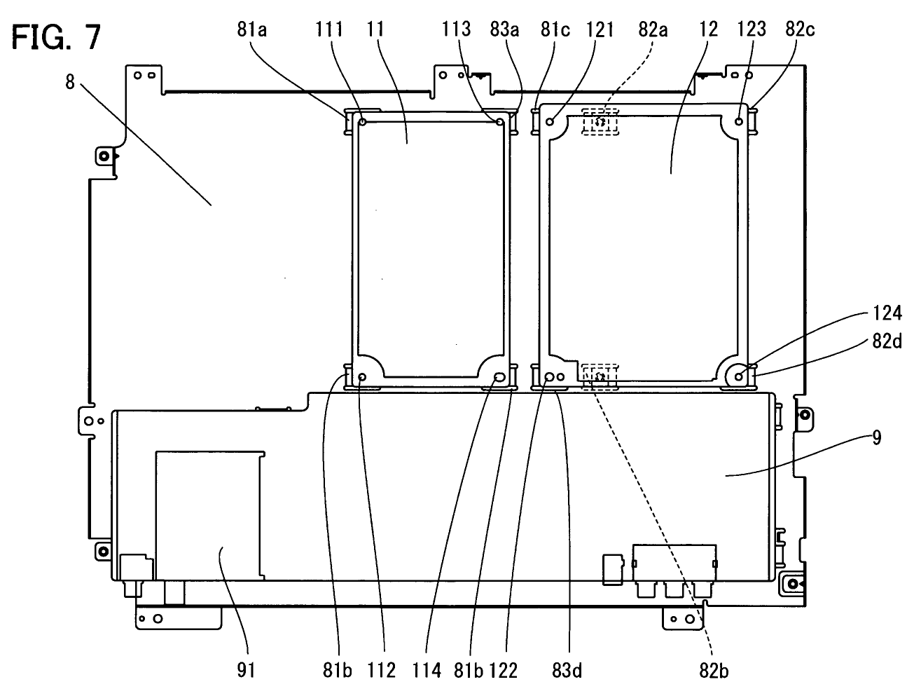

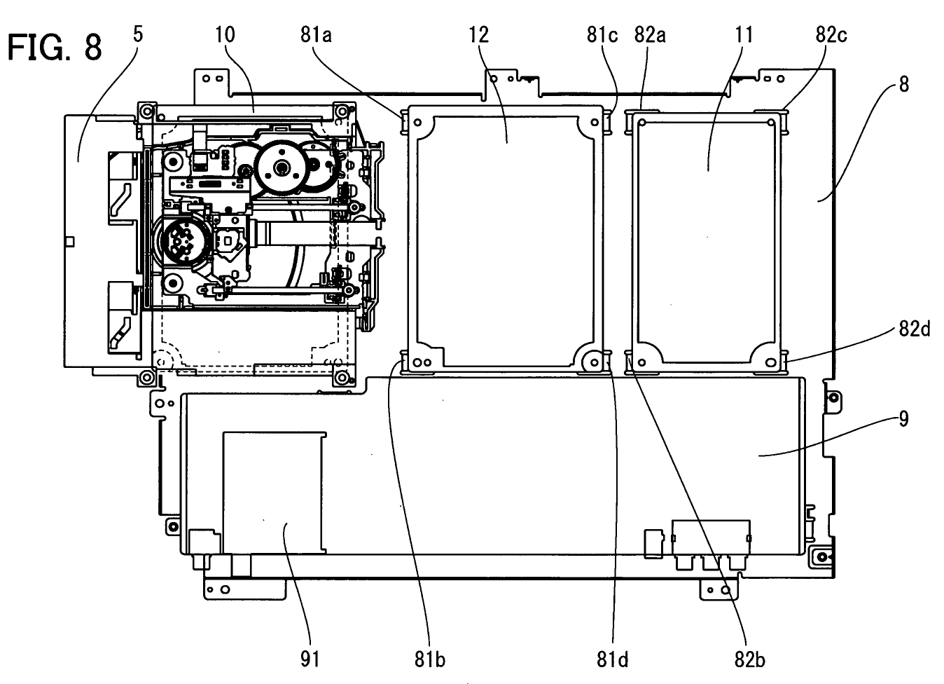

FIG. 1 to FIG. 8 shows the embodiments of the present invention and FIG. 1 is a front view of a liquid crystal television receiver. FIG. 2 is a side view of the liquid crystal television receiver. FIG. 3 is a plan view of the liquid crystal television receiver. FIG. 4 is a rear view of the liquid crystal television receiver with a back cabinet removed. FIG. 5 is a plan view showing an LCD cover provided for the liquid crystal television receiver in the disk device integrated type construction, and the disk device and the substrate arrangement structure of each substrate attached thereto. FIG. 6 is a plan view showing the substrate arrangement structure with no disk device or MPEG substrate attached to the LCD cover and with a power substrate attached instead. FIG. 7 is a plan view showing the substrate arrangement structure with the arrangement of the SCALER substrate and the power substrate shown in FIG. 5 changed. FIG. 8 is a plan view showing the substrate arrangement structure with the MPEG substrate shown in FIG. 4 and the disk device arranged in a multilayer form and the power substrate arranged at the original location of the MPEG substrate.

### Embodiment 1

The construction of the liquid crystal television receiver according to this embodiment will be explained based on FIGS. 1 to 4. FIG. 1 is a front view of a liquid crystal television receiver which is of a disk device integrated type and reference numeral 1 denotes a liquid crystal television receiver. Reference numeral 2 denotes a front cabinet and 3 denotes a 14-inch size liquid crystal panel on which received videos are displayed. Reference numeral 4 denotes a leg. FIG. 2 is a side view showing the side of a disk insertion slot of the liquid crystal television receiver 1. Reference numeral 5 denotes a disk device which performs reproduction or reproduction/recording of a DVD (Digital Versatile Disc) and 51 denotes a disk insertion slot to set a disk in the disk device 5. FIG. 3 is a plan view showing the upper part of the liquid crystal television receiver 1. Reference numeral 6 denotes a back cabinet, 7 denotes operation sections to operate the liquid crystal television receiver 1 and 71 denotes operation buttons for operating television functions of the liquid crystal television receiver and 72 denotes operation buttons for performing operations related to the disk device. FIG. 4 is a rear view of the liquid crystal television receiver 1 with the back cabinet 6 removed. Reference numeral 8 denotes an LCD cover made of a metal which sandwiches the liquid crystal panel 3 with the front cabinet 2 and fixes various substrates and the disk device 5 which will be described later to shield the liquid crystal panel 3 against noise generated from the various substrates. Reference numeral 9 denotes a main substrate having a tuner and outside input terminals. Reference numeral 10 denotes an MPEG substrate which expands and decodes a video/audio signal obtained from the disk device 5 and 11 denotes a SCALER substrate which converts a video signal to a signal for displaying videos on the liquid crystal panel.

Next, a disk device integrated type construction and a non-integrated type construction of the liquid crystal television receiver will be explained based on FIGS. 5 and 6. FIG. 5 is a plan view showing the LCD cover and various parts attached thereto of the liquid crystal television receiver in the disk device integrated type construction. The main substrate 9 is arranged in the lower half part of the LCD cover 8, and the disk device 5, MPEG substrate 10 and SCALER substrate 11 are arranged in that order in the upper half part thereof. Mounting holes 101, 102, 103, 104 are formed in the MPEG substrate 10 and mounting holes 111, 112, 113, 114 are also formed in the SCALER substrate 11 in the same way. The LCD cover 8 is provided with mounting parts 81a, 81b, 81c, 81d for mounting the MPEG substrate 10 and mounting parts 82a, 82b, 82c, 82d for mounting the SCALER substrate 11.

FIG. 6 is a plan view showing the LCD cover and various parts attached thereto of the liquid crystal television receiver in a disk device non-integrated type construction. Reference numeral 12 denotes a power substrate for supplying power to the liquid crystal television receiver 1. In comparison with FIG. 5, the disk device 5 is removed and the power substrate 12 is arranged at the location at which the MPEG substrate 10 is mounted. Mounting holes 121, 122, 123, 124 of this power substrate 12 are formed to the same size and at the same intervals as the mounting holes 101, 102, 103, 104 of the MPEG substrate 10 respectively. This allows the power substrate 12 to be mounted using the mounting parts 81a, 81b, 81c, 81d of the LCD cover of the MPEG substrate 10. That is, the MPEG substrate 10 and the power substrate 12 can use common mounting parts. Hereinafter, the mounting parts 81a, 81b, 81c, 81d will be generally referred to as “common mounting parts.”

Next, the construction which allows the positional relation between the MPEG substrate 10 or power substrate 12 and the SCALER substrate 11 to be changed will be explained based on FIG. 7. Reference numerals 83a and 83b denote mounting parts for replacement of substrates used when replacing substrates. Since the outside shape and the size of the mounting holes of the MPEG substrate 10 and the power substrate 12 are the same, only the power substrate 12 will be explained hereinafter. First, the distance between the mounting holes 121 and 122 of the power substrate 12 is made to be the same as the distance between the mounting holes 111 and 112 of the SCALER substrate 11. In the same way, the distance between the mounting holes 123 and 124 of the power substrate 12 is made to be the same as the distance between the mounting holes 113 and 114 of the SCALER substrate 11. Next, the common mounting parts 81a, 81b, 81c, 81d are positioned at appropriate distances from the disk device 5 based on the size of the MPEG substrate 10 or power substrate 12. Next, the mounting parts 82a, 82b, 82c, 82d for the SCALER substrate will be positioned, but in this case, the mounting part 82c for the SCALER substrate is positioned at a distance from the common mounting part 81c corresponding to the distance between the common mounting parts 81a and 81c. In the same way, the mounting part 82d for the SCALER substrate is positioned at a distance from the common mounting part 81d corresponding to the distance between the common mounting part 81b and 81d. Since the mounting parts 82c and 82d for the SCALER substrate are positioned in this way, the mounting parts 82a and 82b for the SCALER substrate can be positioned based on the size of the SCALER substrate 11.

Furthermore, the mounting parts 83a and 83b for replacement of substrates will be positioned. The mounting part 83a for replacement of substrates is positioned in the direction opposite to the disk reproduction apparatus at the same distance from the common mounting part 81a as the distance between the mounting parts 82a and 82c for the SCALER substrate. In the same way, the mounting part 83b for replacement of substrates is positioned in the direction opposite to the disk reproduction apparatus at the same distance from the common mounting part 81b as the distance between the mounting parts 82b and 82d for the SCALER substrate. With the mounting parts 83a and 83b for replacement of substrates positioned in this way, when, for example, the positional relation between the power substrate 12 and SCALER substrate 11 is changed, the SCALER substrate 11 can be attached to the LCD cover 8 by making the mounting holes 111, 112, 113, 114 thereof correspond to the common mounting part 81a, common mounting part 81b, mounting part 83a for replacement of substrates and mounting part 83b for replacement of substrates respectively, and at this time, the power substrate 12 can be attached to the LCD cover 8 by making the mounting holes 121, 122, 123, 124 of the power substrate 12 correspond to the common mounting part 81c, common mounting part 81d, mounting part 82c for the SCALER substrate and mounting part 82d for the SCALER substrate respectively.

As shown above, according to the substrate arrangement structure of the liquid crystal television receiver 1, when both the disk device 5 integrated type construction and the non-integrated type construction are manufactured, if many parts common to both constructions are used, the MPEG substrate 10 and power substrate 12 can be attached using the common mounting parts 81a, 81b, 81c, 81d, and it is thereby possible to provide commonality of the shape of the LCD cover and provide space saving for the liquid crystal television receiver 1 in the disk device non-integrated type construction which requires no disk device 5 or MPEG substrate 10 without the need for an outside power device such as an AC adapter which is indispensable for a conventional 14-inch size small liquid crystal television receiver. Furthermore, the positional relation between the MPEG substrate 10 or power substrate 12 and SCALER substrate 11 can be changed using the mounting parts 83a and 83b for replacement, and therefore when, for example, the MPEG substrate 10 and power substrate 12 need to be placed apart from parts affecting the operation due to interference of noise of a tuner 91 or the like arranged on the main substrate 9, it is possible to change the substrate arrangement flexibly and at low cost without the need to form a new LCD cover 8 or add parts.

### Embodiment 2

The construction of a liquid crystal television receiver according to this embodiment will be explained based on FIG. 8. As shown in FIG. 8, an MPEG substrate 10 is arranged between a disk device 5 and an LCD cover 8 in such a way that the disk device 5 overlaps therewith. Since the MPEG substrate 10 does not occupy common mounting parts 81a, 81b, 81c, 81d, a power substrate 12 is mounted here. This allows space saving also for a disk device integrated type construction of a liquid crystal television receiver without the need for an outside power device such as an AC adapter.

The embodiments of the present invention have been explained in detail so far, but the present invention is not limited to each of the above described embodiments and can be implemented modified in various ways within a range not departing from the essence of the present invention. For example, the disk device 5 has been assumed to be one that performs reproduction or recording/reproduction of a DVD, but the present invention is not limited to this and there will be no problem with a disk device using CD, CD-R, CD-RW or other recording media. Furthermore, the liquid crystal panel has been assumed to be of a 14-inch size, but the present invention is not limited to this and there will be no problem if the present invention is applied to a 15-inch liquid crystal panel.

The effects of the present invention are as follows.

The liquid crystal television receiver according to the first aspect of the present invention comprises a liquid crystal panel which displays videos, a SCALER substrate which converts a video signal to a signal for displaying videos on the liquid crystal panel, a main substrate provided with a tuner which receives a broadcast radio wave and performs tuning or channel selection and a video/audio processing circuit and an outside input/output terminal or the like, power supply means for supplying power to the whole device through the main substrate, an LCD (Liquid Crystal Display) cover which is a cover for attaching the liquid crystal panel to protect the back of the liquid crystal panel and attaching various circuit substrates and the disk device or the like, a disk device capable of performing reproduction or recording and reproduction of a recording medium and a MPEG substrate which performs expansion and decoding of a video/audio signal obtained from the disk device, wherein the power supply means in the case of a disk device integrated type construction is used as an AC adapter connected from outside the device, the power supply means in the case of a disk device non-integrated type construction is used as a power substrate mounted inside the device, a plurality of mounting holes of the same size are formed for attaching the MPEG substrate and the power substrate to the LCD cover and mounting parts formed in the LCD cover for attaching the MPEG substrate and the power substrate are formed as common mounting parts to serve for both substrates, and the MPEG substrate is attached to the common mounting parts in the case of the disk device integrated type construction and the power substrate is attached to the common mounting parts in the case of the disk device non-integrated type construction, and therefore when configured as the disk device non-integrated type liquid crystal television receiver, it is possible to mount the power substrate in the space produced by removing the disk device and MPEG substrate, eliminate the necessity for the AC adapter and provide space saving and when configured as the disk device integrated type liquid crystal television receiver, it is possible to mount the disk device and MPEG substrate and supply power using the AC adapter. That is, in the liquid crystal television receiver of two types; disk device integrated type and non-integrated type, it is possible to use the LCD cover as a common part, constitute the substrate and electronic parts mounted thereon using more common parts and thereby save costs for dies for creating LCD covers specific to the disk device integrated type and non-integrated type, suppress increases in the number of components and facilitate management.

The liquid crystal television receiver according to the second aspect of the present invention is the liquid crystal television receiver according to the first aspect of the present invention, wherein mounting parts of the main substrate are arranged below the LCD cover, mounting parts of the disk device are arranged above mounting parts of the main substrate and at any one of left and right ends of the LCD cover, mounting parts for the SCALER substrate are arranged at an end opposite to the mounting parts of the disk device, and the common mounting parts are arranged above the mounting parts of the main substrate and at locations adjacent to the mounting parts of the disk device, and therefore it is possible to arrange the MPEG substrate which needs to be electrically connected to the disk device in the vicinity of the disk device, facilitate wiring, and moreover in the case of the disk device non-integrated type construction, when the disk device and MPEG substrate which are unnecessary parts are removed, the parts are adjacent to each other and it is thereby possible to secure wider extra space.

The liquid crystal television receiver according to the third aspect of the present invention is the liquid crystal television receiver according to the first or second aspect of the present invention, wherein the SCALER substrate and the power substrate are provided with mounting holes for mounting on the LCD cover formed at least in four corners of the substrates, the distance between the mounting holes is made to be equal for both substrates at least in a direction identical to a short side of the liquid crystal television receiver, the mounting parts for the SCALER substrate which are most distant from the disk device are positioned at a distance equal to the distance of the four mounting holes of the power substrate in a direction identical to a long side of the liquid crystal television receiver from the common mounting parts which are most distant from the disk device, and further mounting parts for replacement of substrates are positioned and formed at locations in a direction opposite to the disk device from the common mounting parts which are nearest from the disk device and at a distance equal to the distance of the mounting holes of the SCALER substrate in the same direction as that of the long side of the liquid crystal television receiver, and therefore it is possible to interchange the locations of the SCALER substrate and the power substrate, and even when, for example, an electronic part vulnerable to noise is mounted on the main substrate and the power substrate needs to be placed away from this electronic part, it is possible to easily change the arrangement of the power substrate.

The liquid crystal television receiver according to the fourth aspect of the present invention is the liquid crystal television receiver according to any one of the first to third aspects of the present invention, wherein the liquid crystal television receiver in the disk device integrated type construction arranges the MPEG substrate on the disk device in a multilayer form, and arranges the power substrate on the LCD cover instead of the MPEG substrate, and therefore it is possible to mount the power substrate also in the disk device integrated type liquid crystal television receiver, eliminate the necessity for a power supply by an AC adapter and thereby provide space saving.

The liquid crystal television receiver according to the fifth aspect of the present invention is the liquid crystal television receiver according to any one of the first to fourth aspects of the present invention, wherein a diagonal length of a display section of the liquid crystal panel is 14 inches or 15 inches, and therefore it is possible to provide further space saving of the conventional small liquid crystal television receiver.

1. A liquid crystal television receiver which can be configured as a disk device integrated type by comprising:
a liquid crystal panel which displays videos;
a substantially rectangular SCALER substrate which converts a video signal to a signal for displaying videos on the liquid crystal panel;
a main substrate provided with a tuner which receives a broadcast radio wave and performs tuning or channel selection and a video/audio processing circuit and an outside input/output terminal or the like;
power supply means for supplying power to the whole device through the main substrate;
an LCD (Liquid Crystal Display) cover which is a cover for attaching the liquid crystal panel to protect the back of the liquid crystal panel and attaching various circuit substrates and the disk device or the like;
a disk device capable of performing reproduction or recording and reproduction of a recording medium; and
a substantially rectangular MPEG substrate which performs expansion and decoding of a video/audio signal obtained from the disk device;
wherein the power supply means in the case of a disk device integrated type construction is used as an AC adapter connected from outside the device,
the power supply means in the case of a disk device non-integrated type construction is used as a substantially rectangular power substrate mounted inside the device,
a plurality of mounting holes of the same size are formed for attaching the MPEG substrate and the power substrate to the LCD cover and mounting parts formed in the LCD cover for attaching the MPEG substrate and the power substrate are formed as common mounting parts to serve for both substrates, and
the MPEG substrate is attached to the common mounting parts in the case of the disk device integrated type construction and the power substrate is attached to the common mounting parts in the case of the disk device non-integrated type construction.

2. The liquid crystal television receiver according to claim 1, wherein mounting parts of the main substrate are arranged below the LCD cover,
mounting parts of the disk device are arranged above mounting parts of the main substrate and at any one of left and right ends of the LCD cover,
mounting parts for the SCALER substrate for mounting the SCALER substrate are arranged at an end opposite to the mounting parts of the disk device, and
the common mounting parts are arranged above the mounting parts of the main substrate and at locations adjacent to the mounting parts of the disk device.

3. The liquid crystal television receiver according to claim 1, wherein the SCALER substrate and the power substrate are provided with mounting holes for mounting on the LCD cover formed at least in four corners of the substrates, the distance between the mounting holes is made to be equal for both substrates at least in a direction identical to a short side of the liquid crystal television receiver,
the mounting parts for the SCALER substrate which are most distant from the disk device are positioned at a distance equal to the distance of the four mounting holes of the power substrate in a direction identical to a long side of the liquid crystal television receiver from the common mounting parts which are most distant from the disk device, and
further mounting parts for replacement of substrates are positioned and formed at locations in a direction opposite to the disk device from the common mounting parts which are nearest from the disk device and at a distance equal to the distance of the mounting holes of the SCALER substrate in the same direction as that of the long side of the liquid crystal television receiver.

4. The liquid crystal television receiver according to claim 1, wherein the liquid crystal television receiver in the disk device integrated type construction arranges the MPEG substrate on the disk device in a multilayer form, and
arranges the power substrate on the LCD cover instead of the MPEG substrate.

5. The liquid crystal television receiver according to claim 1, wherein a diagonal length of a display section of the liquid crystal panel is 14 inches or 15 inches.

6. The liquid crystal television receiver according to claim 2, wherein the SCALER substrate and the power substrate are provided with mounting holes for mounting on the LCD cover formed at least in four corners of the substrates, the distance between the mounting holes is made to be equal for both substrates at least in a direction identical to a short side of the liquid crystal television receiver,
the mounting parts for the SCALER substrate which are most distant from the disk device are positioned at a distance equal to the distance of the four mounting holes of the power substrate in a direction identical to a long side of the liquid crystal television receiver from the common mounting parts which are most distant from the disk device, and
further mounting parts for replacement of substrates are positioned and formed at locations in a direction opposite to the disk device from the common mounting parts which are nearest from the disk device and at a distance equal to the distance of the mounting holes of the SCALER substrate in the same direction as that of the long side of the liquid crystal television receiver.

7. The liquid crystal television receiver according to claim 2, wherein the liquid crystal television receiver in the disk device integrated type construction arranges the MPEG substrate on the disk device in a multilayer form, and
arranges the power substrate on the LCD cover instead of the MPEG substrate.

8. The liquid crystal television receiver according to claim 3, wherein the liquid crystal television receiver in the disk device integrated type construction arranges the MPEG substrate on the disk device in a multilayer form, and
arranges the power substrate on the LCD cover instead of the MPEG substrate.

9. The liquid crystal television receiver according to claim 6, wherein the liquid crystal television receiver in the disk device integrated type construction arranges the MPEG substrate on the disk device in a multilayer form, and
arranges the power substrate on the LCD cover instead of the MPEG substrate.

10. The liquid crystal television receiver according to claim 2, wherein a diagonal length of a display section of the liquid crystal panel is 14 inches or 15 inches.

11. The liquid crystal television receiver according to claim 3, wherein a diagonal length of a display section of the liquid crystal panel is 14 inches or 15 inches.

12. The liquid crystal television receiver according to claim 4, wherein a diagonal length of a display section of the liquid crystal panel is 14 inches or 15 inches.

13. The liquid crystal television receiver according to claim 6, wherein a diagonal length of a display section of the liquid crystal panel is 14 inches or 15 inches.

14. The liquid crystal television receiver according to claim 7, wherein a diagonal length of a display section of the liquid crystal panel is 14 inches or 15 inches.

15. The liquid crystal television receiver according to claim 8, wherein a diagonal length of a display section of the liquid crystal panel is 14 inches or 15 inches.

16. The liquid crystal television receiver according to claim 9, wherein a diagonal length of a display section of the liquid crystal panel is 14 inches or 15 inches.
